(19) United States
(12) Patent Application Publication
(10) Pub. No.: US 2002/0116387 A1
(43) Pub. Date: Aug. 22, 2002

(54) Translation devices, methods and software for moving information between a database file, and a source or destination file

(76) Inventors: Azadeh Farahmand, Plano, TX (US); John Schomp, Dallas, TX (US)

Correspondence Address: Steven W. Thrasher, Jackson Walker, L.L.P., 2435 North Central Expressway, Suite 600, Richardson, TX, 75080, US

(21) Appl. No.: 09/777,070

(22) Filed: Feb. 5, 2001

(51) Int. Cl. G06F 7/00

(52) U.S. Cl. 707/102

(57) ABSTRACT

The present invention achieves technical advantages as devices, software, and methods for generating a database file, such as an OBDC compliant database file, based on the contents of a character file, such as an ASCII character file. The preferred device is a computer system in a healthcare network that generates a payer claim form based on a provider claim form. The method generally receives a character file, selects a map, and uses the map to generate a database file. To practice the method, software may be loaded onto a computing platform and then executed according to the method. Furthermore, the invention may be embodied on a software medium, such as a CD ROM, or transmitted over the internet as a data signal. Also, the invention may be reversed in operation to produce a character file based on a database file.

### TECHNICAL FIELD

Generally, the invention relates to computers, software and the Internet, and more specifically, the invention relates to devices, methods, and software for generating standard-independent character files, and for generating database files based on standard-independent character files.

### STATEMENT OF A PROBLEM ADDRESSED BY THIS INVENTION

Insurance claims forms (or, “claims forms”) are used by health care providers (providers), such as physician offices and hospitals, to collect information needed to process a healthcare claim for a patient. These forms are typically paper-based hard copies.

To process a claim, a provider fills out the form either by hand or with a typewriter. Then, the insurance company, HMO, PPO, or other healthcare payer (payer) uses the information (data) on the form to process the claims. For example, a payer processing a claim determines if a patient is a covered patient, and seeks to discover if the visit to the provider or the illness is one that is covered under a patient's policy, and so forth.

Unfortunately, claims forms are often returned to the provider without being processed. For example, claims forms may contain clerical or other errors, and so must be returned to the provider for correction. Also, because of mail routing within an office, as well as the time it takes to physically deliver mail by the postal service, delays of days or weeks in the payment of the claim may occur. Other time delaying events in the processing of claim forms include delays associated with substantive errors in claim form entries, as well as disputes over an entry, or even disputes over a claim itself. Furthermore, if more than one time delaying event occurs with a particular claim, such as if one delay is caused by an entry being disputed, and a second delay is caused by mail routing, delays of even months are possible.

Recently, to decrease claim form processing time, payers have been accepting claim forms through electronic venues, such as through email. For example, one payer provides physician offices with text software that contains electronic insurance claims forms, along with instructions for filling out the claim forms electronically. Then, once the claims forms are completed, the provider sends the electronic claims forms to the payer as an attachment to an email message, or via other electronic means. Another payer allows providers to electronically scan their forms and convert the scanned forms into ASCII character files. The ASCII character files are then sent to the payer as an email attachment. These methods of claim processing provide the key feature of eliminating the time it takes to transfer physical documents from one location to another location.

Unfortunately, providers typically deal with several payers, each of who has a different claim form. This makes it difficult to keep track of which claims forms to use and which software to use for each patient/provider/payer relationship. Predictably, mistakes (such as sending the correct form for a patient to an incorrect payer) are not uncommon. Furthermore, when a mistake occurs, a payer has no obligation to inform a provider of the mistake. This may lead providers to incorrectly believe that a claim form is properly being processed. Accordingly, to overcome these and other disadvantages associated with existing methods of processing a claim form, it would be advantageous for providers to use the data entry system of their choosing, and at the same time allow payers to continue to use the claims processing systems they prefer.

### SELECTED OVERVIEW OF SELECTED EMBODIMENTS

The present invention achieves technical advantages as devices, software, and methods for generating a database file. The database file is preferably an OBDC compliant database file that is constructed based on the contents of a character file, such as an ASCII character file. The preferred device is a computer system in a healthcare network that generates a payer claim form based on a provider claim form. The method generally receives a character file, selects a map, and uses the map to generate a database file. To practice the method, software may be loaded onto a computing platform and then executed according to the method. Furthermore, the invention may be embodied on a software storage medium (such as a CD ROM), or transmitted over the internet as a data signal. Also, the invention may be reversed in operation to produce a character file based on a database file. Thus, the present invention automatically produces healthcare payer database files based on a provider character file.

In one embodiment the present invention is a method of generating a database file. The method generally receives a character file having data therein, selects a map based on the character file, and uses the map to generate the database file. The method may be modified in numerous embodiments. For example, the database file may have a database file type preselected by a healthcare payer.

In another embodiment, the invention is a method of generating a payer claim form based on a provider claim form where the method receives the provider claim form, identifies a provider claim form type, identifies a payer claim form type, selects a map based on the provider claim form type and the payer claim form types, and uses the map to generate the payer claim form.

In yet another embodiment, the invention is a method of using a map to generate a database file based on a character file. Accordingly, the method searches a line of characters, detects a data (at a line number and column number), associates the data with a database record element (based on the line number and the column number), and generates a database entry (having the data).

Furthermore, another embodiment is provided where in a healthcare network, the invention is a method of using a map to generate a payer claim form based on data in a provider claim form. The method comprises the acts of locating a map having a database record entry, associating the database record entry with a location in a character file, searching the character file, locating data at the location in the character file, and copying the data from the character file to the database record entry.

Another embodiment of the invention is provided as a method of using a map to generate a payer claim form based on a provider claim form. The method searches a line of the provider claim form for data, detects data, associates the data with an element of the payer claim form, and copies the data from the provider claim form to the associated elements of the payer claim form.

Another embodiment of the invention is a method in a computer system for the dynamic association of a date location in a provider claim form with a data record in a payer claim form. This method comprises receiving the provider claim form, selecting a map based on a provider claim form type and a payer claim form type, and using the map to associate a location in a provider claim form with a data record in a payer claim form.

In a healthcare network computer system, another embodiment of the invention is provided as a method of using a map to generate a payer claim form based on a provider claim form. The method searches a line of the provider claim form for data, detects data, associates the data with an element of the payer claim form, and copies the data from the provider claim form to the associated elements of the payer claim form.

In another aspect, the invention is a computer system in a healthcare network. The computer system is for generating a payer claim form based on a provider claim form. The computer system receives the provider claim form, identifies a provider claim form type, identifies a payer claim form type, selects a map based on the provider claim form type and the payer claim form types and uses the map generating the payer claim form.

A further embodiment is provided as a computer system in a healthcare network. The computer system is for generating a payer claim based on a provider claim form. Accordingly, the computer system includes a server that searches a line of the provider claim form for data, detects data, associates the data with an element of the payer claim form, copies the data from the provider claim form to the associated elements of the payer claim form. The computer system also includes a client machine in communication with the server.

Another embodiment of the invention is provided as a computer-readable medium whose contents cause, in a healthcare network, the dynamic association in a computer system for the dynamic association of a date location in a provider claim form with a data record in a payer claim form. The contents cause the receiving the provider claim form, the selecting a map based on a provider claim form type and a payer claim form type, and the using the map to associate a location in a provider claim form with a data record in a payer claim form.

A further embodiment of the invention is realized as a computer-readable medium whose contents cause, in a healthcare network, the generation of a payer claim form based on a provider claim form. The contents cause the searching of a line of the provider claim form for data, the detecting of data, the associating of the data with an element of the payer claim form, and the copying of the data from the provider claim form to the associated elements of the payer claim form

Another embodiment of the invention is a computer-readable medium whose contents transforms a computer system into a payer claim form generation system. The payer claim form generation system includes a receiving subsystem, a map selection subsystem, and a generating subsystem.

The invention can also be configured to be a computer-readable medium whose contents transform a computer system into a payer claim form entry association system. The a payer claim form entry association system includes a searching subsystem, a detection subsystem, an association subsystem, and a copying subsystem.

Yet another embodiment of the invention provides a computer-readable data signal embodied on a transmission medium. The computer readable data signal comprises a first code segment having an association between a location in a provider claim form and an element in a payer claim form, and a second code segment having data associated with the location.

An additional embodiment of the invention provides a computer memory containing a data structure for the dynamic association of a location in a provider claim form with an element in a payer claim form. The computer memory includes a fist data table containing a data entry for each location in a provider claim form that may contain data, and a data entry for each element in a payer claim form that may contain data, and includes a second data table containing a data entry for each provider claim form type, a data entry for each payer claim form type, and a data entry identifying a map associated with each provider claim form type and each payer claim form type.

An additional embodiment of the invention may be realized as a data signal comprising a data structure for the dynamic association of a location in a provider claim form with an element in a payer claim form. The data signal includes a fist data table containing a data entry for each location in a provider claim form that may contain data, and a data entry for each element in a payer claim form that may contain data and includes a second data table containing a data entry for each provider claim form type, a data entry for each payer claim form type, and a data entry identifying a map associated with each provider claim form type and each payer claim form type.

### BRIEF DESCRIPTION OF THE DRAWINGS

Various aspects of the invention, as well as an embodiment, are better understood by reference to the following EXEMPLARY EMBODIMENT OF A BEST MODE. To better understand the invention, the EXEMPLARY EMBODIMENT OF A BEST MODE should be read in conjunction with the drawings in which:

FIG. 1 illustrates a typical Intranet architecture that supports an embodiment of the system;

FIG. 2 shows a common Internet/WAN architecture for providing a system according to the invention;

FIG. 3a presents a remote database system for implementing the invention having a remote database in an Internet architecture;

FIG. 3b illustrates an architecture that allows for the remote processing of a provider claim form;

FIG. 4 is a block flow diagram illustrating an embodiment of an association algorithm;

FIG. 5 is a flow chart of the acts used to accomplish an analysis algorithm;

FIG. 6 illustrates an exemplary provider claim form;

FIG. 7 illustrates an exemplary database record generated according to the mapping of Table B; and

FIG. 8 provides Table A and Table B.

### AN EXEMPLARY EMBODIMENT OF A BEST MODE

The invention provides devices, software, and methods that generate a database file based on a character file, or may produce a character file based on a database file. In a healthcare provider network, the invention uses tables to associate data in a specific location in a character file with a data field of a data record. The table may be embodied as a map which is selected to provide translations between a particular provider format and a particular payer format. By associating a specific location in a character file with a specific field in a data record, the data located at the specific location can be copied to the specific field in the data record. Likewise, the data in the field can be copied to the specific location in the character file. Accordingly, the invention incorporates databases of tables and executable algorithms to exchange information between a provider format and a payer format. This achieves one of the advantages the invention provides over the prior art—the automatic generation of a desired file type.

When reading this section (entitled An Exemplary Embodiment of a Best Mode, which describes an exemplary embodiment of the best mode of the invention known to the inventor at the time the application is filed, hereinafter “exemplary embodiment”), one should keep in mind several points. First, the following exemplary embodiment is what the inventor believes to be the best mode for practicing the invention at the time this patent was filed. Thus, since one of ordinary skill in the art may recognize from the following exemplary embodiment that substantially equivalent structures or substantially equivalent acts may be used to achieve the same results in exactly the same way, or to achieve the same results in a not dissimilar way, the exemplary embodiment should not be interpreted as limiting the invention to one embodiment.

Likewise, individual aspects (sometimes called species) of the invention are provided as examples, and, accordingly, one of ordinary skill in the art may recognize from a following exemplary structure (or a following exemplary act) that a substantially equivalent structure or substantially equivalent act may be used to either achieve the same results in substantially the same way, or to achieve the same results in a not dissimilar way.

Accordingly, the discussion of a species (or a specific item) invokes the genus (the class of items) to which that species belongs, as well as related species in that genus. Likewise, the recitation of a genus invokes the species known in the art. Furthermore, it is recognized that as technology develops, a number of additional alternatives to achieve an aspect of the invention may arise. Such advances are hereby incorporated within their respective genus, and should be recognized as being functionally equivalent or structurally equivalent to the aspect shown or described.

Second, the only essential aspects of the invention are identified by the claims. Thus, aspects of the invention, including elements, acts, functions, and relationships (shown or described), should not be interpreted as being essential unless they are explicitly described and identified as being essential. Third, a function or an act should be interpreted as incorporating all modes of doing that function or act, unless otherwise explicitly stated. For example, one recognizes that “tacking” may be done by nailing, stapling, gluing, hot gunning, riveting, etc., and so a use of the word tacking invokes stapling, gluing, etc., and all other modes of that word and similar words, such as “attaching”.

Fourth, unless explicitly stated otherwise, conjunctive words (such as “or”, “and”, “including”, or “comprising”, for example) should be interpreted in the inclusive, not the exclusive, sense. Fifth, the words “means” and “step” are provided only to facilitate the reader's understanding of the invention and do not invoke “means” or “step” as defined in §112, paragraph 6 of 35 U.S.C., unless used as “means for -functioning-” or “step for -functioning-” in the Claims section.

Computer Systems as an Exemplary Device

A computer system typically includes hardware capable of executing machine readable instructions, as well as the software for executing acts (typically machine-readable instructions) that produce a desired result. In addition, a computer system may include hybrids of hardware and software, as well as computer sub-systems.

Hardware generally includes processor-capable platforms, such as client-machines (also known as personal computers or servers), and hand-held processing devices such as smart phones or personal digital assistants (PDAs), or personal computing devices (PCDs), for example. Furthermore, hardware also typically includes any physical devices that are capable of storing machine-readable instructions, such as memory or other data storage devices. Other forms of hardware include video displays, hardware sub-systems including data transfer devices such as modems, modem cards, ports, and port cards, for example. The organization of hardware within a system is known as the system's architecture (discussed below).

Software includes machine code stored in RAM or ROM, machine code stored on other devices (such as floppy disks, or a CD ROM, for example), and may include executable code, an operating system, as well as source or object code, for example. In addition, software encompasses any set of instructions capable of being executed on a client machine or server—and, in this form, is often called a program or executable code.

Programs often execute in portions of code at a time. These portions of code are sometimes called modules or code-segments. Often, but not always, these code segments are identified by a particular function that they perform. For example, a counting module (or “counting code segment”) may monitor the value of a variable. Furthermore, the execution of a code segment or module is sometimes called an act. Accordingly, software may be used to perform a method, and the method may comprise acts. In the present discussion, sometimes acts are described as having steps to help the reader more completely understand the exemplary embodiment by avoiding the use of the term “sub-act”. Thus, the word step should not be interpreted as §112, paragraph 6 of 35 U.S.C.

Hybrids (combinations of software and hardware) are becoming more common as devices for providing enhanced functionality and performance to computer systems. A hybrid is created when what are traditionally software functions are directly manufactured into a silicon chip—this is possible since software may be assembled and compiled into ones and zeros, and, similarly, ones and zeros can be represented directly in silicon. Typically, the hybrid (manufactured hardware) functions are designed to operate seamlessly with software. Accordingly, it should be understood that hybrids and other combinations of hardware and software are also included within the definition of a computer system and are thus envisioned by the invention as possible equivalent structures and equivalent methods.

Computer sub-systems are combinations of hardware and/or software (or hybrids) that perform some specific task. For example, one computer sub-system is a soundcard. A soundcard provides hardware connections, memory, and hardware devices for enabling sounds to be produced and recorded by a computer system. Likewise, a soundcard may also include software needed to enable a computer system to “see” the soundcard, recognize the soundcard, and drive the soundcard. This software is sometimes called a “driver”.

Sometimes the methods of the invention may be practiced by placing the invention on a computer-readable medium. Computer-readable mediums include passive data storage, such as a random access memory (RAM) as well as semi-permanent data storage such as a compact disk read only memory (CD-ROM). In addition, the invention may be embodied in the RAM of a computer and effectively transform a standard computer into a new specific computing machine.

Data structures are defined organizations of data and enable an embodiment of the invention. For example, a data structure may provide an organization of data, or an organization of executable code (executable software). Furthermore, data signals are carried across transmission mediums (such as coaxial cable, twisted pair cable, or radio waves) and store and transport various data structures, and, thus, may be used to transport the invention. It should be noted in the following discussion that acts with like names are performed in like manners, unless otherwise stated.

Exemplary Architectures

The invention should not be interpreted as being limited to any specific architecture. However, a better understanding of the invention can be achieved by examining some common architectures on which the invention can be implemented. Since software running on a single computer is well known in the art, a discussion of a single computer architecture will not be discussed here.

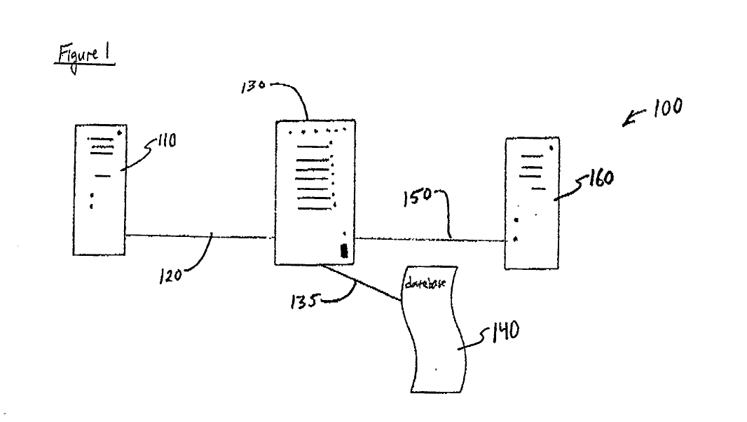

Some physician healthcare networks, as well as some hospital networks, may be self-insured and may operate on an Intranet. FIG. 1 illustrates a typical Intranet architecture 100 that supports an embodiment of the invention. In an Intranet architecture 100, a client machine 110 (such as a personal computer (PC), a laptop, a palm device, or a smart phone, for example) communicates with a server 130 across a connection 120 that may be any transmission medium, such as a wire-line (such as a twisted pair, coaxial, or fiber-optic, for example) or wireless mediums (for example, infra red (IR) or radio waves passing through the air). The client machine 110 will typically be used by a physician or a physician assistant. Thus, generally, in the figures, a solid line connecting devices typically represents a transmission medium that terminates into transmission devices, such that a transmission medium includes any material capable of passing a machine-readable signal. Likewise, though not shown, common transmission devices include modems and network cards, for example.

The server 130 is preferably a computing machine for sending, receiving, and processing email, and is preferably a “high-end” (or more powerful) computing device. However, the server 130 could be any computing device and is primarily defined by its functionality (discussed in greater detail later). In an Intranet, an email server may be a standard personal computer with an Ethernet (or other networking) card, and thus needs only one connected client machine to create a network.

A local database is a database that is accessible by a server device without the server device having to connect with a network (Intranet, Internet, Local Area Network (LAN), or Wide Area Network (WAN), for example). The server 130 has access across a link 135 (which could be a connection to another piece of hardware, or a connection with memory internal to the server 130) to a database 140, which is illustrated in FIG. 1 as a local database. The database 140 could be any standard or proprietary database software, such as Oracle, Microsoft Access, SyBase, or DBase II, for example. Accordingly, the database 140 has fields, records, data, and other database elements which may be associated through database specific executable software code. In this embodiment of the invention, one field of one table is allocated for data regarding providers of healthcare services, and another field of the table is allocated for data regarding payers of insurance claims. Additionally, preferably in another table, one field is allocated to identify the location of data in a character file, while another field is allocated to identify a field in a third table that contains the same data.

Mapping is the process of associating one data entry with another data entry. For example, the data contained in the location of a character file can be mapped with the above mentioned table to a field in a second table. This process is discussed in detail in an example provided later.

A second connection 150, which is similar to (but not necessarily the same as) the first connection 140, is provided in the Intranet architecture 100, and couples the server 130 with a second client machine 160 which will typically be a payer or payment center. Thus, an email or other transmission may be sent from the client machine 110 to the server 130 where the email and/or an attachment will be processed according to a method of the invention. Then, the processed email or attachment will be sent to the second client machine 160. Likewise, an email could be generated by the second client machine 160, processed by software in the server 130, and then forwarded to the client machine 110 as a processed email or attachment.

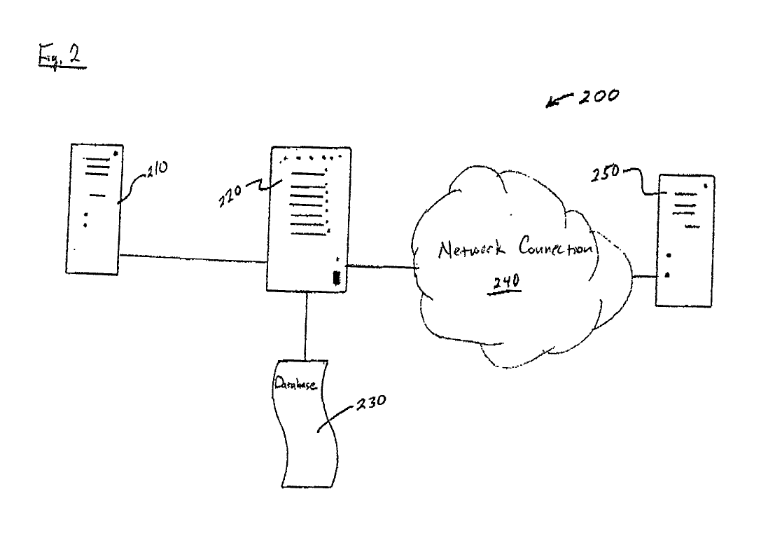

Similarly, the invention may operate across the Internet, or a WAN. FIG. 2 shows a common Internet/WAN architecture 200 for providing a system according to the invention. The remaining discussion will focus on the Internet embodiment of the architecture, although it should be understood that any network that allows remote networking can be represented by substituting that network platform for the Internet. For example, a satellite communications system may be used as a transmission medium in a WAN.

In FIG. 2 a client machine 210 is coupled to a email server 220 having a local database 230. Similarly, the email server 220 is connected to a network connection 240. Although the Internet is the preferred communications network connection which couples the server 220 to a second client machine 250, it should be understood that in addition to being replaced by other existing communications systems, the Internet may be replaced by any successor or successors to the Internet.

Continuing with the email illustration, when an outgoing email is processed by the invention, the email is written on the client machine 210 and is destined for the second client machine 250. As the email is routed from the client machine 210 to the second client machine 250 the server 220 receives the email, and then applies the teachings of the invention to the email. Accordingly, the server 220 identifies in the email data representative of a provider claim form. This data may be provided as on email attachment or may be contained in the body of the email. Then, the server 220 associates the received email with a destination payer in order to select a map (or table). The selected map is then used to locate data in the provider claim form, and to place the data in a payer claim form. This processed data is then embodied in an email attachment and is attached to an email, or may be placed in the body of an email. The resulting email is called a processed email.

The processed email is then sent across the Internet 240 to the second client machine 250. Accordingly, the processed email may be opened by the user at the second client machine 250. Likewise, an email may be generated at the second client machine 250, routed through the Internet 240, and received by the server 220. Then, the server 220 may apply the teachings of the invention to the email, and then send a new processed email to the client machine 210.

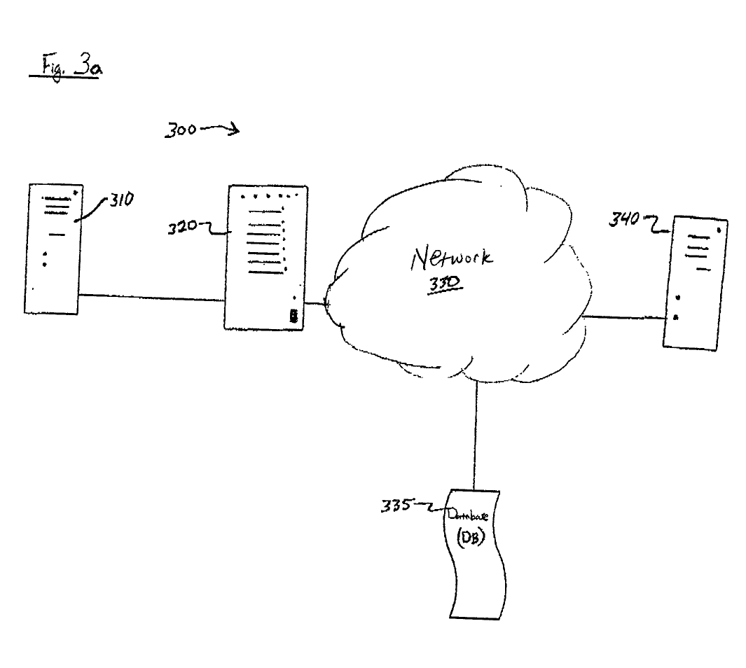

The location of the database should not be interpreted as limiting. For example, the database may exist remotely from the server, and run on a separate platform that is accessible across the Internet or another network, such as on an Application Service Provider (ASP), or another server, for example. FIG. 3a presents a remote database system 300 for implementing the in an Internet architecture. The path of an email through the system of FIG. 3a is similar to the path of an email through the system of FIG. 2. However, the processing of an email in the remote database system 300 differs in that when performing an association, the remote database system 300 will access a remote database 335, which may reside in one or more remote servers, or one or more application service providers (ASPs).

Accordingly, an email is generated at a client machine 310 and then routed to a server 320. The server 320 contains executable code for enabling the invention. Thus, the server 320 processes the email received from the client machine 320. To do this, the server 320 accesses the remote database 335 across the Internet 330, which of course, could be any network. Accordingly, patient information found in the email received from the client machine 310 can be matched to a database entry via mapping the data from a provider claim form to a payer claim form via the database 335. The payer claim form, or associated data, is returned to the server 320 across the Internet 330. Then, the processed email is sent from the server 320 across the Internet 330 to a second client machine 340.

In another architecture, a server and a database may be located remotely from the other parts of the computer system, and remotely from each other. FIG. 3b illustrates an architecture that allows for the remote processing of a provider claim form. A client machine 360 provides a source of data associated with a provider's patient. This data may then be transferred to a network 370, such as the Internet, by means such as an email or an internet form, or the data may be accessed directly in the client machine 360, for example. Accordingly, the provider claim form data is transferred across the Internet 370 to a server 380 for processing. As discussed above, the server 380 may process the provider claim form using either local databases 382, or remote databases 384, or both. The optional nature of the databases 382, 384 is illustrated and emphasized by dotted lines which represent the transmission path to and from the databases 382, 384. Following the processing of the provider claim form, the server 380 transfers the processed data to a second client machine 390 either as a processed email, or by providing some other means of data transfer, such as an internet form or direct remote file access.

Note that more than one database may be implemented in an architecture. For example, one or more databases may be implemented locally, while at the same time one or more databases are implemented remotely. This allows for associations to be made automatically, in the background (without a user's awareness), and for databases to examine each others' fields (this may facilitate keeping information current). Furthermore, though the architectures disclosed are described functionally in terms of an email transfer, it should be noted that data transfers may take many additional forms, such as the direct accessing of a file by a remote device in any of the illustrated architectures. Accordingly, the present invention incorporates these additional forms of data access.

Exemplary Methods

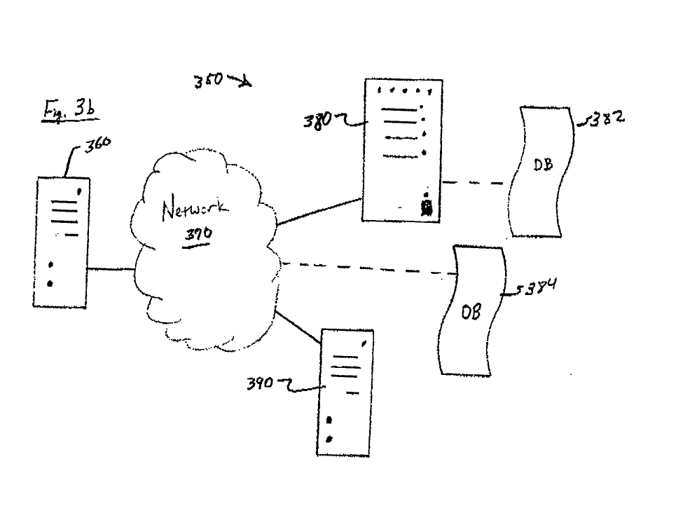

The methods taught by the invention are preferably implemented as software, and in one embodiment, the invention is a method of associating a provider and a payer with a map. FIG. 4 is a block flow-chart of a method of the invention implemented as an Association algorithm 400.

The association algorithm 400 begins with a data input act 410. Generally, the data input act 410 includes inputting patient information (data) into a claim form. The data includes information such as the patient's name, address, insurance provider, medical background, and information regarding that patient's claim. Of course, other information may be provided and encompassed within the definition of data. The data generated in the data input act 410 may be generated at the provider, such as at a physician's office, or at another healthcare service provider's office. Furthermore, the data may be generated at a payer's office or at any other physical location.

Data may be recorded by scanning a written or typed document, by data entry via keyboarding directly into computer software, or by using voice recognition (voice to text) software systems. Typically, the data generated in the data input act 410 will be stored in a single character file, such as an ASCII character file. Accordingly, the character file containing the data is then forwarded or sent from the input location, or retrieved by an outside computer system.

The association algorithm 400 then proceeds to a receive data act 420. In the receive data act 420 the character file having data therein is received by the association algorithm 400. It should be noted, however, that although an ASCII character file is described herein, any character file (such as that used for Microsoft Word, or rich text format (RTF), for example) may be encompassed in the meaning of a character file. Furthermore, the received data act 420 may receive the character file via any HTTP or WWW transfer, including by receiving an email having the character file attached thereto, by using a file transfer protocol (FTP) (which may be established at a predetermined time), or by providing the payer direct access to a file containing the character file via a database log-in, a web page log-in, or other log-in system (this access is provided across a network, and called a direct file access).

Then, particularly when generating a payer form based on a provider character file, in an identify (ID) provider act 430, the healthcare provider responsible for generating the data is identified. The ID provider act 430 may be accomplished by detecting the email address from which an attached character file was sent, by identifying an email address to which the character file was sent (for example, each physician provider may be assigned a specific email address to send his or her claims forms to), or by examining a specific entry or set of entries within the character file itself.

Likewise, particularly when generating a report for a provider based on payer data, in an ID payer act 440, the payer is identified in a similar manner. For example, in the ID payer act 440, the payer may be identified by detecting the email address to which the ultimate data base file is to be sent, detecting the email address in which the character file resides (for example, each physician provider may be assigned a specific email address to send a character file to based on the payer who is to receive the file), or by detecting a character or characters representative of that provider in a line of code in the character file. Next, the association algorithm 400 proceeds to a select map act 450.

In the select map act 450 a processing map is selected by associating an appropriate processing map to the identified provider or the identified payer. Table A is an alternative embodiment of a table for selecting a map based on an identification of both a provider and a payer. For example, in reference to Table A, if a provider, such as Dr. B, is the identified provider, and payer Q is the identified payer, Table A will map Dr. B and payer Q to map M0014. This identifies this map as the appropriate processing map. Accordingly, map M0014 is used to transfer data between a character file associated with provider Dr. B and a database file associated with payer Q.

Note that the foregoing example specifically calls out a map based on an identified payer and an identified provider. However, this is not always necessary. For example, it is often acceptable to identify only either the payer or provider. Then, an appropriate map may be selected for generating a claim form based on either the payer or provider. Likewise, a map may be selected for generating a provider report based on either an identified payer or an identified provider. In these cases, Table A would comprise a payer or a provider column, and a second column containing the associated map entry. In any event, the map is preferably identifiable via either Parsemaster or Winmap. Following the selection of the processing map in the select map act 450 the association algorithm 400 proceeds to a processing act 460.

The processing act 460 uses the processing map(s) selected in the select map act 450 to copy data between the character files generated by the provider and an internal database, or to a final destination file. Table B represents map M00014 and, accordingly, is a processing table for mapping the location of data in a provider claim form to a record in a payer claim form or vice versa.

The processing act 460 continues, in reference to Table B (also known as map M0014), by locating data in the character file at the location defined as the first row, first column (1,1) through the first row and fifteenth column (1,15). Although the location is in this example mapped to a database field, it should be noted that prior to the execution of the method, typically no such database exist. In other words, the processing map identifies the desired field for data associated with a location. Accordingly, the processing act 460 will often create a data base file of records. However, this is not always the case. The processing act 460 may map directly from an internal database to a second character file, or, alternatively, map directly from a first character file to a second character file. Furthermore, the database may be an internal database which can be mapped to an ASCII file, or other character file type used by the recipient (whether a payer or provider).

Thus, data within the identified location is mapped to (associated with) the first field (F1) of the generated database. Then, the processing act 460 copies the data in the location from the location to the appropriate field in the database. In addition, a processing table may contain additional fields of information such as data regarding the maximum length of a data record, as well as data identifying the data type for a record. In the event that the internal database was created based on mapping only one of the payer or provider, additional processing is needed to convert the internal database into a file type needed by the recipient. Accordingly, if a map was selected based on only the payer, then the association algorithm 400 returns to the identify provider act 430. Likewise, if a map was selected based on only the provider, then the association algorithm 400 returns to the identify payer act 440. Then processing proceeds through the select map act 450 and the processing act 460, as discussed.

The database (or file) created by the processing act 460 is stored in a computer system memory. Then, the association algorithm 400 may proceed to an output file act 470. The output file act 470 may send the file, which may be a database, a NSF file, an X12 file, or an ASCII file, for example, to a more permanent storage device, or may send the database to a payer. The output file may be sent to a payer as an email, an email attachment, or via a file transfer protocol. Furthermore, the output file may be accessed by a provider across a network. In other words, the output file act 470 may (but does not have to) transfer the database in a way similar to the receive data act 420.

It should be noted that the association algorithm 400 may be performed in reverse so that a database file from a payer may be transferred into a character file for a provider.

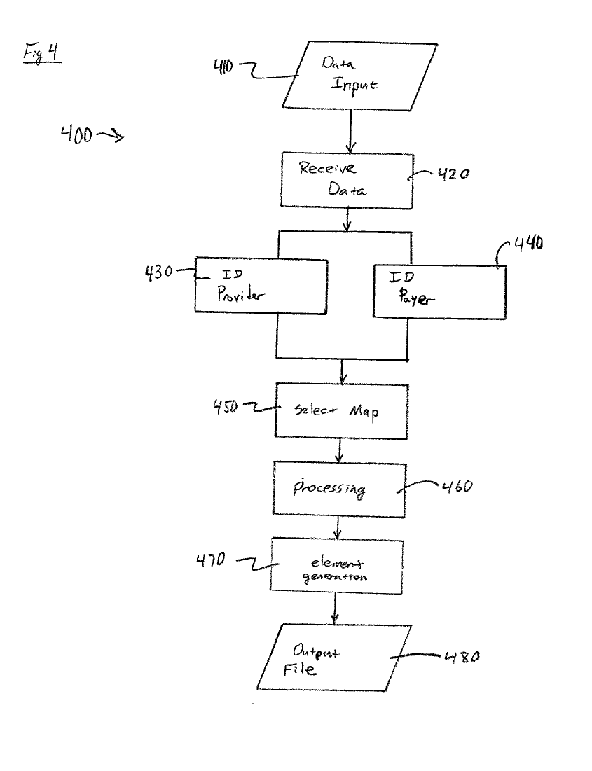

FIG. 5 is a flow chart of the acts used to accomplish an analysis algorithm 500. The analysis algorithm 500 begins with a load map act 510. In the load map act 510 a processing map is loaded into a memory of a computer system. However, in addition to loading a map, or as an alternative to loading a map, various algorithms or modules may be implemented in order to perform substantially the same act and achieve substantially the same results in a similar method. For example, the load map act 510 may load the processing map associated with provider Dr. B with payer Q (map M0014).

Next, the analysis algorithm 500 proceeds to a load character line act 520. In the load character line act 520 the character file (typically the provider claim form) is loaded into the memory of the computer system. Preferably, the load character line act at 520 preserves the line status of each line of the character file. In other words, as an example, line 1 of the character file as sent by the provider is line 1 stored in memory, likewise, line 2 of the provider character file is identified as a line 2 in memory. Alternatively, a line identifier may be used prior to each line of data in memory to identify a line of data. Of course, alternative methods of identifying lines are possible and may be used without departing from the invention.

The analysis algorithm 500 next proceeds to a set variables act 530. The set variables act 530 resets any counting variables, and may also establish a first maximum value for the number of columns in the character file, and a second maximum value for the number of lines in the character file. Then, the analysis algorithm 500 continues to a search line act 540 in which a line of the processing table is accessed and the analysis algorithm 500 looks for data in the character file at the location identified in the processing map. For example, in reference to Table B, the search line act 540 will look for a character at line 1, column 1 (1,1) of the character file.

Next, in a detect data query 550, it is determined whether or not data exists at the location identified in the character file, preferably by the (row, column) convention. If no data is detected in the detect data query 550, the analysis algorithm 500 directs the database to enter a “null” character or characters for the data associated with the data location, increments a counting variable, and returns to the search line at 540.

If, however, in the detect data query 550, data is detected in the identified location (here, the first row and first column) of the character file, the analysis algorithm 500 proceeds to a map act 560. A start location is defined as a data location identified in the (row, column) convention, being the first data point of a data location, and is further defined and identified as having a (start row , start column) convention. Similarly, a termination location is defined as a data location identified in the (row, column) convention, being the final data point of a data location, and is further defined and identified as having a (termination row, termination column) convention. In the map act 560 data from a start row and a start column to a termination row and termination column is copied and then transferred to a field as directed the processing table.

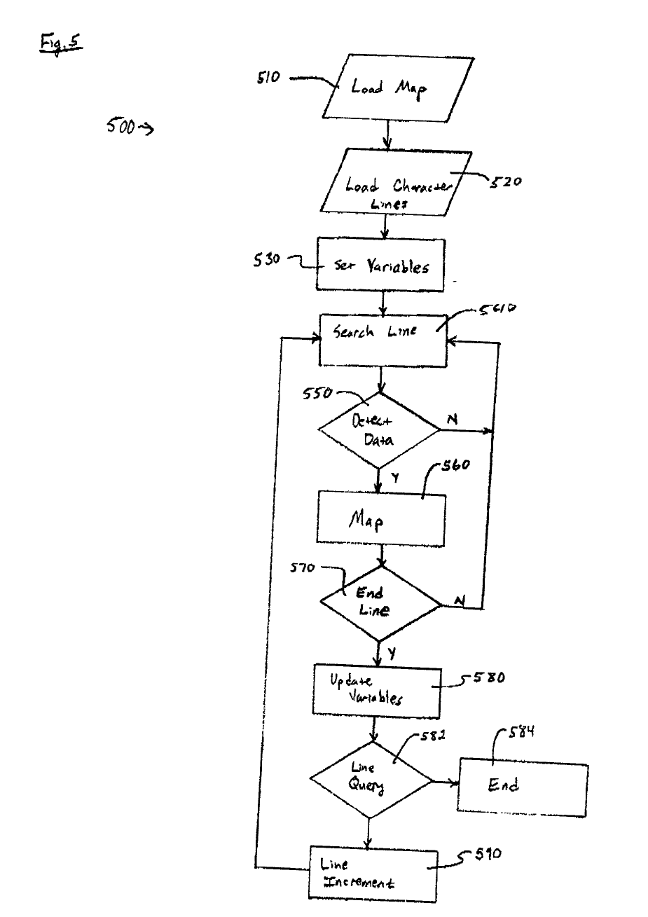

FIG. 6 illustrates an exemplary provider claim form. Although FIG. 6 illustrates data for each individual (preferably a patient) on a single character line, it should be understood that the data for an individual may exist on more than one line, or that data for multiple individuals may exist on a single character line. Furthermore, although the provider claim form of FIG. 6 illustrates data aligned in columns, it should be understood that data need not be so alive.

To continue with the example, in reference to Table B, data is located in the provider claim form illustrated in FIG. 6. Accordingly, in the map act 560 the L of the name Lynda is identified in row 1 and column 1 of the character file. Thus, Table B is referenced and indicates that the character file is to be copied from a start row (row 1) and a start column (column 1), to a termination row (row 1) and a termination column (column 15). Next, the data contained between the start location and the terminal location is copied and transferred to the new database, in the new database's field F1.

Accordingly, the information copied, according to Table B, contains the name Lynda Paramore. This name is then transferred to a database having the field F1, and a new record is begun.

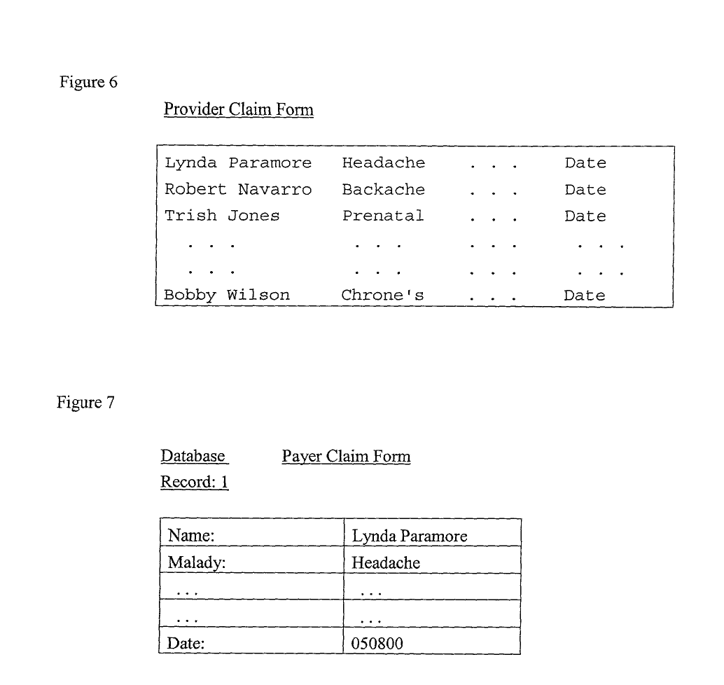

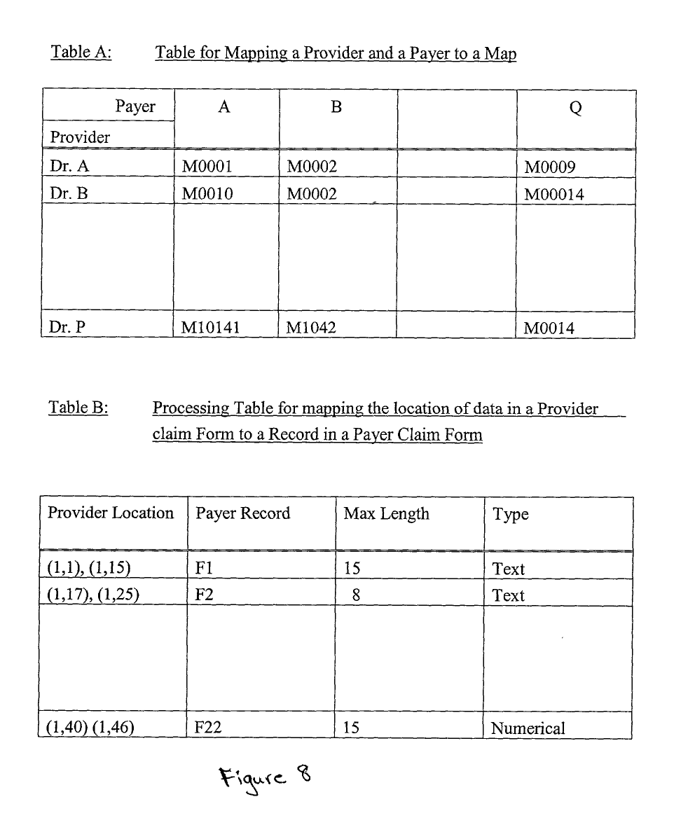

FIG. 7 illustrates an exemplary database record generated according to the mapping of Table B. FIG. 7 shows that the data copied from the character file is pasted into the database field F1 for a new record. More specifically, the name Lynda Paramore is copied from the character file and then pasted into the database file as shown in FIG. 7. It should be noted that preferably a new record is created for each new data set. For the example, a new data record is created for each line of data in the character file.

After the data is copied from the provider claim form and pasted into an internal database or directly into a payer claim form, the payer claim form the analysis algorithm 500 proceeds to an end line query 570. In the end line query 570 the analysis algorithm 500 determines whether or not the end of a character line in the character file has been reached. If, in the end line query 570, the end of a line has not been reached, the analysis algorithm 500 returns to the search line at 540. If, however, the end line query 570 determines that the end of the line has been reached, the analysis algorithm 500 proceeds to an update variable act 580. In the update variable 580, the variable that counts the line is incremented, the variable that tracks the column number is reset, and any other desired variable associations are made.

Next, the analysis algorithm 500 proceeds to a line query 582. In the line query 582 it is determined if the line that was just processed in the map act 560 is the last line in the character file. If the line that was processed is the last line, the analysis algorithm 500 terminates execution in an end act 584. However, if the line query 582 determines that the line that was processed is not the last line of the character file, the analysis algorithm 500 continues to a line increment act 590. In the line increment act 590, the analysis algorithm 500 loads the next line of the character file into the appropriate location in memory so that it may be analyzed by the analysis algorithm 500.

Though the invention has been described with respect to a specific preferred embodiment, many variations and modifications will become apparent to those skilled in the art upon reading the present application. It is therefore the intention that the appended claims be interpreted as broadly as possible in view of the prior art to include all such variations and modifications.

I claim:

1. A method of generating a database file, the database file based on a source file, the method comprising:
receiving the source file, the source file having data therein;
selecting a map based on the source file; and
using the map to generate the database file.

2. The method of claim 1 wherein the database file has a predefined database structure.

3. The method of claim 1 further comprising the act identifying a source file type.

4. The method of claim 3 wherein the text file type is identified by identifying a source of the character file.

5. The method of claim 1 further comprising the acts of scanning a document to create a scanned image, and converting the scanned image to the source file.

6. The method of claim 1 further comprising the act of producing the source file via data entry.

7. The method of claim 1 further comprising the act of identifying a desired database file type.

8. The method of claim 7 further comprising the act of selecting the map based on the desired database file type.

9. The method of claim 7 further comprising the act of selecting the map based on the source of an input file.

10. The method of claim 1 further comprising the act of sending the database file to a predetermined location.

11. The method of claim 10 wherein the predetermined location is an internal database.

12. The method of claim 1 wherein the source file is a character file.

13. In a healthcare network, a method of generating a payer claim form based on a provider claim form, the method comprising:
receiving the provider claim form;
identifying a provider claim form type;
identifying a payer claim form type;
selecting a map based on the provider claim form type and the payer claim form type; and
using the map to generate a database file.

14. The method of claim 13 further comprising the act of using the map to generate the payer claim form.

15. The method of claim 13 further comprising the acts of:
identifying a payer based on data in the database file;
selecting a map based on the database file; and
generating an output payer claim form based on the database file.

16. The method of claim 13 wherein the provider claim form is an ASCII character file.

17. The method of claim 13 wherein the act of identifying a provider claim form type identifies the provider claim form type based on an identification source selected from the group consisting of an email address, a web log-in, a File Transfer Protocol (FTP) log-in, or a dial-up location.

18. The method of claim 13 wherein the act of identifying a provider claim form type identifies the provider claim form type based on an entry in the character file.

19. The method of claim 13 wherein the act of generating the payer claim form analyzes an ASCII character file on a line-by-line basis.

20. The method of claim 13 further comprising the acts of:
selecting a plurality of maps based on the provider claim form type and the payer claim form type; and
using the plurality of maps to generate the payer claim form.

21. A method of using a map to generate a database file based on a character file comprising:
searching a line of characters for a data;
detecting a data;
associating the data with a database field; and
generating a database entry comprising the data.

22. The method of claim 21 wherein act of detecting detects the data based on at least a line number and a column number of the character file.

23. The method of claim 22 wherein the act of associating associates the data based on a line number and a column number of the character file.

24. The method of claim 22 wherein the database entry contains the data.

25. The method of claim 22 further comprising the act of loading a map into memory.

26. The method of claim 22 further comprising the act of loading a line of the character file into a memory.

27. The method of claim 22 further comprising the act of storing the database in memory.

28. The method of claim 22 further comprising the act of repeating the act of searching to locate a second data.

29. The method of claim 22 wherein the character file is an ASCII character file.

30. In a healthcare network, a method of using a map to generate a payer claim form based on data in a provider claim form, comprising:
locating in a map a database field entry for a record;
associating the database field entry with a location in a character file;
searching the character file;
locating data at the location in the character file; and
copying the data from the character file to the database record entry.

31. The method of claim 30 further comprising the act of loading the map file into a memory.

32. The method of claim 30 further comprising the act of locating the map into a memory.

33. The method of claim 30 further comprising the act of locating a second database entry.

34. The method of claim 30 wherein the location is identified by a line number and a column number.

35. The method of claim 30 wherein the act of searching searches at approximately the location.

36. The method of claim 30 further comprising the act of searching for an start location and a termination location.

37. The method of claim 30 wherein the act of copying copies the data from a start location to a termination location.

38. A method of using a map to generate a payer claim form based on a provider claim form, comprising:
searching a line of the provider claim form for a start location;
detecting the start location;
associating the start location with a field of the payer claim form; and
copying a data from the start location in the provider claim form to the field.

39. A method in a computer system for the dynamic association of a location in a provider claim form with a field in a record of a database associated with a payer claim form comprising:
receiving the provider claim form;
selecting a map based on a provider claim form type and a payer claim form type; and
using the map to associate a location in a provider claim form with the field.

40. The method of claim 39 wherein the location has data therein.

41. The method of claim 40 further comprising the act of copying the data from the provider claim form to the field.

42. The method of claim 39 further comprising the act repeating the acts of receiving, selecting, using and copying.

43. In a healthcare network computer system, a method of using a map to generate a payer claim form based on a provider claim form, comprising;
searching a line of the provider claim form for data;
detecting data;
associating the data with a field of the payer claim form;
copying the data from the provider claim form to the field.

44. A computer system in a healthcare network, the computer system for generating a payer claim form based on a provider claim form comprising:
receiving the provider claim form;
identifying a provider claim form type;
identifying a payer claim form type;
selecting a map based on the provider claim form type and the payer claim form type; and
using the map generating the payer claim form.

45. A computer system in a healthcare network, the computer system for generating a payer claim based on a provider claim form, the computer system comprising:
a server that
searches a line of the provider claim form for data,
detects data,
associates the data with an element of the payer claim form, and
copies the data from the provider claim form to the associated elements of the payer claim form; and
a client machine in communication with the server.

46. A computer-readable medium whose contents cause, in a healthcare network, the dynamic association of a location in a provider claim form with a field in a database associated with a payer claim form by:
receiving the provider claim form;
selecting a map based on a provider claim form type and a payer claim form type; and
using the map to associate a location in the provider claim form with a field.

47. A computer-readable medium whose contents cause, in a healthcare network, the generation of a payer claim form based on a provider claim form, by:
searching a line of the provider claim form for data;
detecting data;
associating the data with a field of the payer claim form;
copying the data from the provider claim form to the field of the payer claim form

48. A computer-readable medium whose contents transforms a computer system into a payer claim form generation system, comprising:
a receiving subsystem;
a map selection subsystem; and
a generating subsystem.

49. A computer-readable medium whose contents transform a computer system into a payer claim form entry association system, comprising:
a searching subsystem;
a detection subsystem;
an association subsystem; and
a copying subsystem.

50. A computer-readable data signal embodied on a transmission medium, comprising:
a first code segment comprising an association between a location in a provider claim form and a field in a payer claim form; and
a second code segment comprising data associated with the location.

51. A computer memory containing a data structure for the dynamic association of a location in a provider claim form with a field in a payer claim form, comprising:
a fist data table containing
a data entry for each location in a provider claim form that may contain data, and

52. A data signal comprising a data structure for the dynamic association of a location in a provider claim form with an element in a payer claim form, comprising:
a fist data table containing
a data entry for each location in a provider claim form that may contain data, and
a data entry for each field in a payer claim form that may contain data; and
a second data table containing
a data entry for each provider claim form type,
a data entry for each payer claim form type, and
a data entry identifying a map associated with each provider claim form type and each payer claim form type.
